(19) United States
(12) Patent Application Publication
(10) Pub. No.: US 2018/0325145 A1
(43) Pub. Date: Nov. 15, 2018

(54) EDIBLE PET CHEW AND METHOD OF MAKING THE SAME

(71) Applicant: Mars, Incorporated, McLean, VA (US)

(72) Inventors: Allan A. Torney, Brampton (CA); Emine Unlu, Chicago, IL (US); Neil Willcocks, Glencoe, IL (US); Kasim Zubair, Guelph (CA); Tiffany Bierer, Franklin, TN (US); Bradley Quest, Kansas City, MO (US); Alex Camire, Marana, AZ (US); Ralf Bela Reiser, Buffalo, NY (US); Francis S. Shields, Nashville, TN (US)

(73) Assignee: Mars, Incorporated, McLean, VA (US)

(21) Appl. No.: 15/985,087

(22) Filed: May 21, 2018

Related U.S. Application Data
(63) Continuation-in-part of application No. 11/817,384, filed on Sep. 23, 2009.
Application No. 11/817,384 is a continuation-in-part of application No. 14/774,092, filed on Sep. 9, 2015, now abandoned.
Application No. 14/774,092 is a continuation of application No. PCT/US2014/026771, filed on Mar. 13, 2014.
(60) Provisional application No. 60/815,682, filed on Jun. 21, 2006.
(60) Provisional application No. 61/792,805, filed on Mar. 15, 2013.

(51) Int. Cl. A23K 50/42; A23K 20/147; A23K 20/179; A23K 20/189; A23K 20/163; A23K 40/20

(52) U.S. Cl. CPC A23K 50/42; A23K 20/147; A23K 40/20; A23K 20/189; A23K 20/163; A23K 20/179

(57) ABSTRACT

An edible pet chew is disclosed that is comprised of fibrous protein, water absorbing polymer, plasticizer, water, and a combination of anthocyanins and turmeric. The pet chew provides excellent textural properties and improved solubility in the stomach and intestinal environment for improved pet safety.

### CROSS-REFERENCE TO RELATED APPLICATIONS

This application is a continuation-in-part of U.S. application Ser. No. 11/817,384, filed on Sep. 23, 2009, which is 35 U.S.C. 371 of International Application No. PCT/US2007/071750, filed on Jun. 21, 2007, which claims benefit of U.S. Provisional Application No. 60/815,682, filed on Jun. 21, 2006. This application is also a continuation-in-part of U.S. application Ser. No. 14/774,092, filed on Sep. 9, 2015, which is a continuation of International Application No. PCT/US2014/026771, filed on Mar. 13, 2014, which claims benefit of Provisional Application Ser. No. 61/792,805, filed Mar. 15, 2013. Each of these applications is hereby incorporated by reference herein in their entirety for any and all purposes.

### FIELD

The present invention relates to edible pet chews, the compositions from which they are made and methods for making pet chew products. In particular, the pet chew of the present invention is formed from a thermoplastic material comprising fibrous protein, water absorbing polymer, plasticizer, and water. The pet chew additionally comprises a naturally derived green color.

### BACKGROUND

Current pet chew products can be loosely grouped into two categories. One type is relatively hard and friable, which crumbles or breaks down relatively quickly and is more easily digested, but has relatively short lasting times in consumption. The second group is comprised of highly dense or compacted products with more elastic or rubbery properties that are more difficult to chew, harder to digest, and have more extended lasting times in consumption.

There has been a proliferation of pet dental chews in the market, specially designed to address oral care problems. The majority of these products are based on hard textures that require repeated chewing for efficacy. There is ample published literature to support the assertion that dogs chewing of various textures can reduce buildup of tartar (Gorrel and Rawlings, 1996; Rawlings et al., 1998; Gorrel and Bierer; 1999; Gorrel et al., 1999 and Lage at al., 1990).

While such products may offer teeth cleaning functions, in many cases they pose risks to dogs either from physical injury such as gum injury, teeth fracture, and blockage of the digestive system. This situation is further exacerbated by the wide difference in skull (Jaslow, 1987) and breed sizes within the domestic dog genus (Canis lupus familiaris). A chew that may seem perfectly safe for some breeds or skull types may raise safety concerns when offered to different breeds or skull types. There is also the risk of nutrient inadequacy as most of these products are not nutritionally “complete and balanced”.

Other dental chews are made with non-food materials such as thermoplastic polymers that offer no nutritional benefits to dogs. The associated safety risks include blockage of the digestive system since they are not digestible, and in extreme situations may require surgical intervention to correct.

Market trends have also influenced ingredient choice for many pet chews and treats. Of these trends, having products that are made entirely from natural materials provides an advantage in the marketplace and appeals to a large segment of the purchasing public. Additionally, regulatory authorities investigate products that claim to be “all natural” in order to provide some assurance to the public that the products asserting to be “all natural” truly are “all natural.” This is particularly difficult as many products that are natural react with environmental factors over time and are not stable, which results in changes to the appearance, taste, and nutritional value of the pet chews and treats. With respect to colors such as green, finding a natural product that provides a desirable green color and remains that color for an extended period of time has proven to be a difficult task.

There remains a need for a product that is completely edible, long lasting and safe, that is designed to effectively clean teeth without risk of health damage such as choking, tooth damage, intestinal obstruction or other injury. Additionally, there remains a need to produce products, such as the one described above, that are made entirely from natural ingredients and that retain a desired green color over time.

### SUMMARY

This invention is directed to an edible pet chew comprising a fibrous protein in an amount of about 15 to about 90% by weight of the chew, a water absorbing polymer in an amount of about 5 to about 35% by weight of the chew, a plasticizer in an amount of about 5 to about 40% by weight of the chew, and water in an amount of about 1 to about 20% by weight of the chew. The pet chew product is a thermoplasticized molded product that has the texture necessary to function as an oral care device, but reduces the potential that large pieces of the chew will be broken off during chewing and is a highly soluble chew composition in the stomach and intestinal environment of the pet. In preferred embodiments, the water absorbing polymer of the pet chew is gelatin. Most preferably the pet chew is a dog chew that provides oral care benefits.

The invention is further directed to an edible pet chew comprising a naturally-derived green color. The naturally-derived green color is preferably provided by a combination of turmeric and anthocyanins. In a preferred embodiment, the pH of the anthocyanins component is a pH such that the color of the anthocyanins appears blue.

The invention is also directed to the composition used to make the pet chew and the method to prepare the thermoplasticized molded product.

### BRIEF DESCRIPTION OF THE DRAWINGS

FIG. 1 is a diagram of one embodiment of a method of producing a pet chew;

FIG. 2 is a diagram of one embodiment of a method of producing a pet chew;

FIG. 3 is a diagram of one embodiment of a method of producing a pet chew;

FIG. 4 is a schematic of one embodiment of a method of producing a pet chew; and

FIG. 5 is an illustration of one embodiment of a pet chew.

FIG. 6 is a graph of fecal consistency observations made while conducting Example 6.

### DETAILED DESCRIPTION

The present invention is directed to an all natural edible pet chew and methods for manufacturing a nutritious product that is designed to remove plaque and tartar through mechanical abrasion while providing safe occupation and enjoyment. The pet chew of the invention provides rapid breakdown of the product once ingested by the animal and demonstrates significant reduction in plaque and tartar as compared to a standard test diet. The composition of the pet chew creates a nutritious and functional treat, which will promote a healthy life style for the animal. A particularly preferred pet chew is designed for dogs, and most preferably a class of dogs, such as described in U.S. Provisional Application No. 60/815,686, filed Jun. 21, 2006, the entire disclosure of which is incorporated by reference herein.

The edible pet chew composition of the invention is formed from a thermoplastic material comprising a fibrous protein, a water absorbing polymer, a plasticizer, and water. The pet chew of the invention is preferably a mono-component/mono-texture product, although it is also possible that it may form part of a dual component product. As used herein, mono-component/mono-texture product means that the chew product is a substantially homogeneous molded mass that be formed into any shape desired for the pet chew.

The edible pet chew further comprises the combination of turmeric and anthocyanins. Preferably, this combination provides a green color that is naturally-derived. Therefore, in one embodiment, a natural pet chew is provided. The natural pet chew preferably comprises anthocyanins and turmeric in an effective amount to result in the chew being green in color. As used herein, “natural” or a “natural food product” refers to one that does not incorporate any synthetic chemicals, colorings or flavorings. For reference, the FDA does not object to the use of the term “natural” as long as the food does not contain added color, artificial flavors, or synthetic substances.

Anthocyanins are water-soluble vascular pigments that may appear red, purple, or blue depending on the pH. Preferably, they are odorless and nearly flavorless. The source of the anthocyanins is preferably selected from, but not limited to, tissues of higher plants, including leaves, stems, roots, flowers, and fruits. Within the source of anthocyanins, the outer cell layers are preferred, such as, but not limited to the epidermis and peripheral mesophyll cells More specifically, the source of anthocyanins is preferably selected from, but not limited to, Vaccinium species, such as blueberry, cranberry, and bilberry; Rubus berries, including black raspberry, red raspberry, and blackberry; blackcurrant; cherry; eggplant peel; black rice; Concord grape; muscadine grape; red cabbage; violet petals; black soybean; skins of black chokeberry; Amazonian palm berry; blood orange; marion blackberry; cherry; redcurrant; purple corn; and acai. Anthocyanins may also act as antioxidants, relax red blood vessels, and provide anti-inflammatory response in the body. Anthocyanins may also protect against cancer, aging, neurological diseases, inflammation, diabetes, bacterial infections, fibrocystic disease, improve eyesight and combinations thereof, and any of these benefits may be conferred to a chew using one or more anthocyanins as colorants.

Anthocyanins exhibit different colors at different levels of pH. Preferably, the pH of the anthocyanins component that is part of the edible pet chew of the present invention is maintained at a pH at which the anthocyanins appear blue. Preferably, the edible pet chew of the present invention further comprises a pH buffer. The pH buffer is preferably present in an amount that allows the anthocyanins to reach and maintain the appropriate pH so that the anthocyanins appear blue in color. The appropriate pH can be determined depending on the source of anthocyanins selected. For example, red cabbage appears blue at pH 8-9. Where red cabbage provides the anthocyanins, the pH of the anthocyanins in the edible pet chew of the present invention is preferably from pH 4.5-9.

Turmeric or Curcuma longa is a rhizomatous herbaceous perennial plant of the ginger family. The turmeric can be utilized in any form, such as, but not limited to, fresh, leaves, powdered, rhizome powder, and combinations thereof. Preferably, the turmeric is yellow in color. Turmeric may have anti-bacterial and anti-fungal properties along with anti-inflammatory activity, however, and may confer these, and other, benefits to a chew in which turmeric is used as a colorant. Turmeric may also aid in the treatment of inflammatory bowel disease, rheumatoid arthritis, cystic fibrosis, cancer prevention, colon cancer, prostate cancer, depression, may reduce the side effects of chemotherapy drugs, act as natural pain-killer, prevent melanoma, leukemia, provide cardiovascular protection, lower cholesterol, prevent Alzheimer's Disease and improve liver function. The turmeric component used in the present chew may be provided in a composition along with manganese, iron, vitamin B6, fiber, and potassium, and in some embodiments, the turmeric component may be provided in the form of a composition that consists of turmeric, manganese, iron, vitamin B6, fiber and potassium. The turmeric component may also otherwise be nutritionally beneficial to the recipient of the pet treat of the present invention. The pH of the turmeric component is preferably from pH 4.5 to 6.5 for a yellow color and from pH 6.5 to 9 for an orangey hue.

The combined amount of anthocyanins and turmeric is preferably enough to produce a green colored pet chew. Preferably, the green color is similar to or identical to that of the present Greenies® treats (MARS, Inc.). Preferably, the green produced by the combination of anthocyanins and turmeric has a Pantone reference range from about P 163-14 U to P 165-16 U. Alternatively, the green color produced by the combination of anthocyanins and turmeric is preferably from about 560-490 nm wavelength or, alternatively, 540-610 THz frequency. The green color of the pet chew of the present invention, produced by the combination of anthocyanins and turmeric, is preferably similar to or identical to the green color of the present Greenies® product (MARS, Inc.), more preferably within ±20 nm of that green, more preferably within ±10 nm of that green, and most preferably within ±5 nm wavelength of that green color. Alternative, the green color of the pet chew of the present invention, produced by the combination of anthocyanins and turmeric, is preferably similar to or identical to the green color of the present Greenies® product (MARS, Inc.), preferably within ±20 THz of that green, more preferably within ±10 THz of that green, and most preferably within ±5 THz frequency of that green.

The combined amount of the anthocyanins and turmeric is preferably from about 0.005% to 5.0% (by weight) of the formulation of the edible pet chew of the present invention, more preferably from about 0.005% to 4% (by weight) of the formulation, still more preferably from about 0.005% to 3% (by weight) of the formulation, more preferably from about 0.005% to 2% (by weight) of the formulation, and most preferably from about 0.005% to 1% (by weight) of the formulation. In an alternate embodiment, the combination of the anthocyanins and turmeric make up about 0.005% to 0.045% (by weight) of the formulation of the edible pet chew of the present invention.

Preferably, the ratio of anthocyanins to turmeric in the edible pet chew of the present invention is any ratio where the resulting edible pet chew appears green. The ratio of anthocyanins to turmeric is preferably selected from, but not limited to a ratio of about 1:1, a ratio of about 1:1.5, a ratio of about 1:2, a ratio of about 1:2.5, a ratio of about 1:3, a ratio of about 1:3.5, a ratio of about 1:4, a ratio of about 1:4.5, a ratio of about 1:5, a ratio of about 1:5.5; a ratio of about 1:6, a ratio of about 1:6.5, a ratio of about 1:7, a ratio of about 1:7.5; a ratio of about 1:8, a ratio of about 1:8.5, a ratio of about 1:9, a ratio of about 1:9.5, and a ratio of 1:10, where the anthocyanins or turmeric can represent either side of the ratio. For example, embodiments are envisioned where the ratio of turmeric to anthocyanins is 1:2 and the ratio of turmeric to anthocyanins is 2:1.

In one embodiment, the pet chew of the present invention further comprises a pH stabilizer. The pH stabilizer can be any component that acts to stabilize the pH of the pet chew such that the anthocyanins provide a blue color, contributing to the overall green appearance of the pet chew. As a non-limiting example, an enzyme may be added to the pet chew to stabilize the pH of the anthocyanins. The turmeric and anthocyanins may be used along with a pH buffer to act as an indicator showing the oral care effectiveness of the pet chew. As the pet chews the treat, the treat may change color indicating that the requisite level of chewing to clean the pet's teeth has been achieved.

The combination of anthocyanins and turmeric may be mixed with the other liquid ingredients prior to any liquid ingredients in the pet chew being combined with any dry ingredients. For example, the turmeric and anthocyanins may be metered in a glycerin/water mixture and then added to the dry ingredients. Such a step may help ensure the stability of the desired green color.

In a preferred embodiment, a method for providing a food product with a green color is provided. The method generally comprises the steps of adding an amount of turmeric with an amount of anthocyanins to the composition to be used to form the food product, wherein the amount of each is sufficient to provide a green color. The food product may be a pet food product, a pet treat, a pet chew, or other food product. In an alternate embodiment, any food product can be utilized for the method of the present invention and the method is not limited to pet products. Preferably, the combination of the amount of turmeric and anthocyanins produce a green color from P 163-14 U to P 165-16 U on the Pantone Reference Range.

Preferably, a method for naturally coloring a food product green is also disclosed. The method generally comprises the steps of adding an amount of turmeric with an amount of anthocyanins to achieve a green color. Preferably the combined amount of turmeric and anthocyanins produce a green color from P 163-14 U to P 165-16 U on the Pantone Reference Range.

The pet chew exhibits ductile properties so that when chewed, the animal's teeth sink into the product causing the product to break down in a controlled manner under repetitive stress. The edible thermoplastic material can be molded into a variety of shapes to provide good strength and stiffness and other desired physical properties to enhance functionality and chewing enjoyment.

Unlike similar products in the marketplace, in preferred forms, the present pet chew product is designed to be 100% nutritionally complete and balanced for animal nutrition. The softer, chewier texture of the present pet chew improves animal enjoyment and demonstrates enhanced oral care efficacy. The pet chew composition of the invention provides a balanced blend of highly digestible proteins in a matrix of water-soluble materials to improve nutritional performance and animal safety.

The fibrous protein for the pet chew may be derived from animals, but preferably does not include muscle protein, or plants. One skilled in the art would recognize that insubstantial amounts of muscle protein could be present. Fibrous proteins are generally strong and relatively insoluble. Due to such properties, fibrous proteins are important in providing the structural backbone of the pet chew product. Exemplary fibrous proteins include, but are not limited to, wheat protein, wheat gluten, corn zein, corn gluten, soy protein, peanut protein, casein, keratin and mixtures thereof. Particularly preferred fibrous proteins include, without limitation, wheat protein isolate, soy protein isolate, sodium caseinate and mixtures thereof. A highly preferred fibrous protein is a mixture of wheat protein isolate, soy protein isolate and sodium caseinate.

The water absorbing polymer in the pet chew may be a gelling protein, a hydrocolloid, an edible hydrogel, or mixtures thereof. Gelling protein, sometimes known as globular protein, generally comprises globelike proteins that are relatively soluble in aqueous solutions where they form colloidal solutions or gels. Exemplary gelling proteins include, but are not limited to gelatin, albumin, plasma, pea protein, lactoglobulins, surimi (fish) proteins, whey protein and mixtures thereof. A preferred gelling protein is gelatin.

A hydrocolloid may be used in the pet chew composition as the water absorbing polymer. A hydrocolloid is generally defined as a macromolecule (e.g., a carbohydrate polymer or a protein) that is water soluble and forms a gel when combined with water. Exemplary hydrocolloids include, but are not limited to pectins, alginates, agars, carrageenan, xanthan gum, and guar gum.

An edible hydrogel may be used in the pet chew as the water absorbing polymer. The edible hydrogel may be a naturally occurring or synthetic material which swells in water or some liquid, retaining a large amount of the liquid without dissolving. Exemplary hydrogels include, but are not limited to maltodextrins, cetyl alcohol, chitosan, lecithins, polypeptides, waxes, and edible polymers.

In a preferred embodiment, the water absorbing polymer is a gelling protein. The gelling protein may be gelatin, having a bloom strength in a range of about 100 to about 400. Desirably, the gelatin will have a bloom strength in a range of about 100 to about 200.

Plasticizers dissolve in the polymer, separating polymer chains and thus facilitating molecular movement. Plasticizers are commonly used to increase workability, flexibility and extensibility of polymers (Ferry, 1980). Plasticizers also reduce water activity of food systems by binding water that is otherwise available for biological reactions such as microbial growth. Exemplary plasticizers generally used in food applications include, but are not limited to water, polyalcohols (e.g. sorbitol, mannitol, maltitol, glycerol and polyethylene glycol), gum arabic, hydrogenated starch hydrolysate and protein hydrolysate. In a preferred embodiment, the plasticizer is glycerol. In yet another preferred embodiment, the plasticizer is hydrogenated starch hydrolysate.

The pet chew composition may be prepared from a mixture comprising fibrous protein in an amount of about 15 to about 90%, preferably about 20 to about 80%, and more preferably about 30 to about 50% by weight of the composition, water absorbing polymer in an amount of about 5 to about 35%, preferably about 10 to about 30%, and more preferably about 15 to about 25% by weight of the composition, plasticizer in an amount of about 5 to about 40%, preferably about 10 to about 35%, and more preferably about 15 to about 30% by weight of the composition, and water in an amount of about 1 to about 20%, preferably about 2 to about 18%, more preferably about 5 to about 15% by weight of the composition. In a preferred embodiment the pet chew composition will contain starch in an amount less than about 5%, preferably less than about 4% and more preferably less than about 3% by weight of the composition. This composition is thermoplasticized, preferably by extrusion, and molded to form the pet chew product. The pet chew product is preferably formed by injection molding. One skilled in the art will readily recognize that the pet chew of this invention could also be prepared by compression molding, extrusion without molding or tableting techniques.

The properties of the proteinaceous materials used in the pet chew are subject to chemical and physical interactions (e.g., protein/protein and with other materials including water absorbing polymers) to improve their solubility and textural properties to enhance oral care benefits and animal safety. Animal safety is achieved through product design to minimize risk in all areas. Control of texture minimizes risks of dental fractures; controlled product size reduction through chewing reduces risk of choking; and superior solubility/digestibility eliminates risk of intestinal blockage.

The pet chew composition may also contain at least one fat, flavor enhancers, preservatives, nutrients, and/or colorants. As used herein the term “fat” includes edible oils and in preferred embodiments, the fat will be liquid fat at room temperature. Exemplary fats include corn oil, soybean oil, peanut oil, cottonseed oil, grapeseed oil, sunflower oil, flaxseed oil (and other sources of omega-3 and omega-6 fatty acids), vegetable oil, palm kernel oil, olive oil, tallow, lard, shortening, butter and combinations thereof. In a preferred embodiment, the fat is vegetable oil. If fat is present, it will generally be used in a range of about 1 to about 20%, preferably about 1.5 to about 10% and more preferably about 2 to about 5% by weight of the pet chew composition.

Flavors are well known and may be used in the pet chew composition. For example, the use of flavor oils such as rosemary oil, eucalyptus oil and clove oil may be employed. Nutrients include, but are not limited to vitamins, minerals, and functional ingredients. Other ingredients may also be included in the pet chew composition, for example, release agents, stabilizers, and emulsifiers. Colorants are preferably the combination of anthocyanins and turmeric, producing a naturally-derived green color.

In a preferred embodiment, the thermoplastic composition may also contain active ingredients for removal of plaque and tartar, and materials for breath freshening and general oral health.

The pet chew of the present invention demonstrates high flexibility and elastic properties to improve chewing enjoyment and lasting time. The product is designed to break down in a controlled fashion under repetitive chewing. The texture of the pet chew ensures proper balance between animal safety, oral care efficacy, enjoyment and lasting time. Further, the breakdown or fracture of the pet chew of the invention under mechanical stress is controlled to avoid release of large pieces that can be swallowed intact thereby increasing the risk of choking and digestive obstruction.

In an alternate embodiment, the pet chew of the present invention can be formulated using, and may consist essentially of, or consist of, the following ingredients gelatin, wheat protein isolate, glycerin, pea protein, water, potato protein, sodium caseinate, natural poultry flavor, lecithin, minerals (dicalcium phosphate, potassium chloride, magnesium amino acid chelate, calcium carbonate, zinc sulfate, ferrous sulfate, copper sulfate, manganese sulfate, potassium iodide), vitamins (dl-alpha tocopherol acetate [source of vitamin E], L-ascorbyl-2-polyphosphate [source of vitamin C], vitamin B12 supplement, d-calcium pantothenate [vitamin B5], niacin supplement, vitamin A supplement, riboflavin supplement, vitamin D3 supplement, biotin, pyridoxine hydrochloride [vitamin B6], thiamine mononitrate [vitamin B1], folic acid), dried tomato, apple pomace, vegetable oil (preserved with mixed tocopherols), ground flaxseed, dried sweet potato, cranberry fiber, dried cultured skim milk, choline chloride, taurine, decaffeinated green tea extract, carotene, turmeric, and anthocyanins. This embodiment of the pet chew is an all-natural pet chew.

In a further embodiment, the pet chew of the present invention can be formulated for weight loss or maintenance. The lite pet chew preferably has, consists essentially of, or consists of, the following ingredients: rice flour, glycerin, gelatin, wheat flour, water, oat fiber, lecithin, wheat protein isolate, apple pomace, tomato pomace, natural flavor, minerals (dicalcium phosphate, potassium chloride, magnesium amino acid chelate, calcium carbonate, zinc sulfate, ferrous sulfate, copper sulfate, manganese sulfate, potassium iodide), vitamins (dl-alpha tocopherol acetate [source of vitamin E], L-ascorbyl-2-polyphosphate [source of vitamin C], vitamin B12 supplement, d-calcium pantothenate [vitamin B5], niacin supplement, vitamin A supplement, riboflavin supplement, vitamin D3 supplement, biotin, pyridoxine hydrochloride [vitamin B6], thiamine mononitrate [vitamin B1], folic acid), sodium caseinate, ground flaxseed, dried cultured skim milk, choline chloride, taurine, decaffeinated green tea extract, carotene, turmeric, and anthocyanins. This embodiment of the chew is thus a lite, all-natural pet chew.

In yet a further embodiment, the pet chew of the present invention can be formulated for the needs of senior animals. The senior pet chew preferably has, consists essentially of, or consists of, the following ingredients: rice flour, glycerin, gelatin, wheat flour, water, oat fiber, lecithin, apple pomace, wheat protein isolate, dried chicken cartilage (source of glucosamine and chondroitin), tomato pomace, natural flavor, minerals (dicalcium phosphate, potassium chloride, magnesium amino acid chelate, calcium carbonate, zinc sulfate, ferrous sulfate, copper sulfate, manganese sulfate, potassium iodide), vitamins (dl-alpha tocopherol acetate [source of vitamin E], L-ascorbyl-2-polyphosphate [source of vitamin C], vitamin B12 supplement, d-calcium pantothenate [vitamin B5], niacin supplement, vitamin A supplement, riboflavin supplement, vitamin D3 supplement, biotin, pyridoxine hydrochloride [vitamin B6], thiamine mononitrate [vitamin B1], folic acid), vegetable oil (preserved with mixed tocopherols), sodium caseinate, ground flaxseed, dried cultured skim milk, choline chloride, taurine, decaffeinated green tea extract, carotene, turmeric, and anthocyanins. This embodiment of the pet chew is thus an all-natural senior pet chew.

### Extrusion

In a preferred embodiment, extrusion may be used to manufacture the products according to the present invention, preferably twin-screw extrusion for production of pellets. The pellets are subsequently melted and formed into particular shapes by post-extrusion forming, preferably by injection molding. Subsequent to injection molding, individual pieces of the products are trimmed for flash removal followed by cooling prior to packaging.

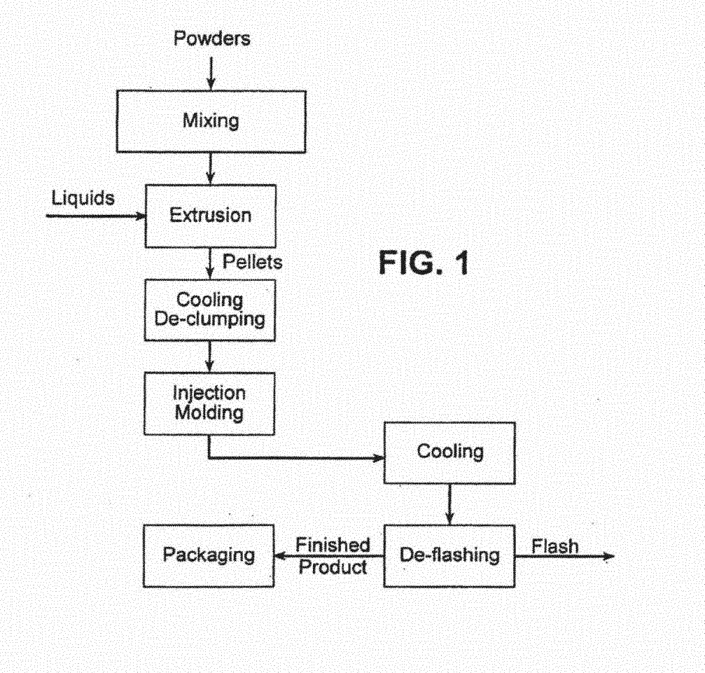

FIG. 1 shows a diagram of an exemplary method of producing the pet chew product according to the invention. As shown in FIG. 1, the manufacturing process from mixing of ingredients to finished product packaging occurs on a continuous basis. Powder ingredients are mixed in the mixer for about 5-30 minutes. Uniform mixture of powder ingredients is subsequently fed into an extruder, preferably a twin-screw extruder. Downstream from the powder inlet, liquid ingredients are added to transform the mixture of powder and liquid ingredients into a uniformly plasticized, moldable mass in the presence of heat and shear. During this process, the moldable mass is also cooked by the increased temperature in the extruder barrels. The temperature profile of the extruder barrels are determined by, among others, the composition, pressure, residence time in the extruder barrels, screw profile, screw speed and shear rate.

The temperature and shear in the extruder zones will be set to provide sufficient thermoplastification. This may be achieved with temperatures in a range of about 88° C. to about 141° C. in the middle zones and lower temperatures at either end of the barrel. Of course, greater temperatures may be employed in the middle zones.

Thus, the temperature can be controlled across the barrel to enable optional venting of energy and moisture along the extruder. Forced venting may also be achieved by using vent/vacuum stuffers at the end of process section where most cooking is achieved on the moldable mass inside the extruder barrel.

At the extruder exit, extrudate is forced through a die with small orifices. Immediately behind the die, the extrudate is exposed to increasing pressure and temperature due to the restriction imposed by the small die openings thus use of extra cooling becomes increasingly important to ensure pellet quality.

Subsequent to exiting the extruder die, the plasticized extrudate is cut at the die surface by a surface cutter equipped with at least one blade in to small pellets. Rotational speed of the cutter may be adjusted depending on the size requirements of the pellets in addition to flow properties of the extrudate. Product temperature at the die exit may range from about 82° C. to about 95° C., and is most preferably about 85° C.

After cutting, pellets are placed on moving conveyors to carry the pellets away from the extruder exit. This process also facilitates cooling of the pellets to prevent caking which reduces the need for a subsequent de-clumping step in the process sequence. Conveyors may be kept at ambient temperatures, however, in order to reduce cooling time, forced air circulation with chiller air may be applied to induce rapid cooling.

Depending on the formulation, speed and extent of cooling, pellets may stick together forming clumps of variable sizes. These clumps must be reduced in size, achieved by de-clumping, to ensure a steady and stable injection molding process.

Subsequent to cooling and de-clumping, pellets are conveyed to injection molding, where the final product shape is achieved.

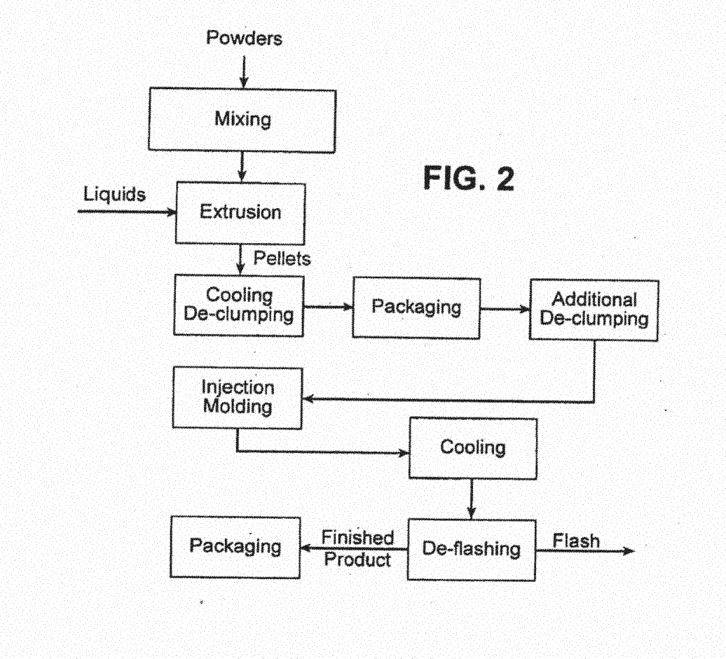

An alternative manufacturing process can be seen in FIG. 2. FIG. 2 shows a diagram of another exemplary method of producing the pet chew product according to the invention, in which pellets are manufactured well prior to being used in injection molding.

While the mixing occurs, extrusion, cooling and de-clumping steps may be similar to that described above (see FIG. 1), in the alternative manufacturing process illustrated in FIG. 2, pellets are packed into suitable containers upon cooling or de-clumping. For packaging, totes, sacks, super-sacks, barrels, cartons, etc. may be used for storage and transfer. The selection of packaging depends on, among others, packing characteristics of pellets, environmental and safety regulations, handling/transportation requirements, usage frequencies and sizes.

Pellet containers must be appropriate for target use and inert enough to protect their contents from external elements such as insects, birds, dust, temperature and humidity fluctuations, sun exposure, aroma and flavor transfer/leach from the containers.

Prior to injection molding, an additional de-clumping process may be required to break up clumps into individual pellets again if packing or clumping of pellets is observed in the containers during storage or transport. Upon de-clumping, pellets are molded into final product shape by injection molding as described below.

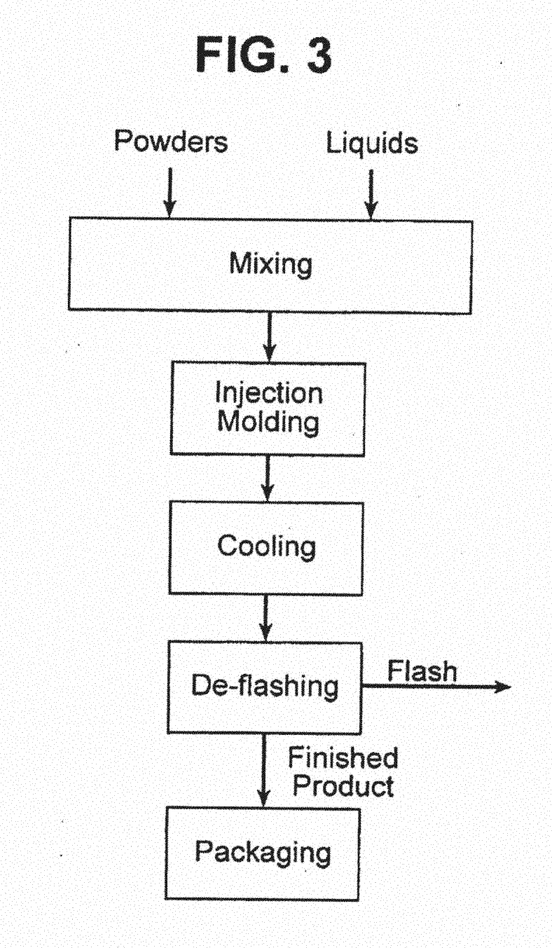

FIG. 3 shows yet another diagram of an exemplary method of producing the pet chew product according to the invention. The process, shown in FIG. 3, combines powder and liquid ingredients together in a high shear mixer to form a uniform mass. According to the process shown in FIG. 3, the pellet production step is also eliminated by feeding the uniform mass directly into the injection molder's barrel.

Subsequent to injection molding, the product is cooled and subjected to a de-flashing process where excess material on the product is removed. De-flashing may be achieved by vibration of product inside vibrating hoppers, vibrating tables and/or tumblers.

### Injection Molding

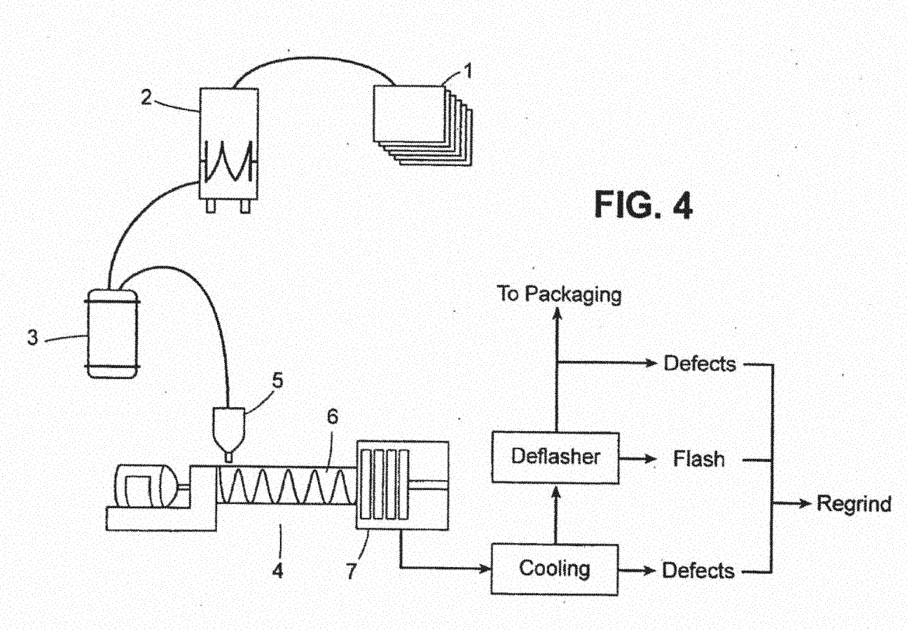

FIG. 4 shows a schematic drawing of the injection molding process that may be used to prepare the pet chew product according to the invention. Material for the injection molding process may be delivered in containers 1 in the form of pellets. Occasionally, due to transport, load pressure and the nature of the recipe, the pellets have a tendency to pack together and form large adhesive blocks. Thus, if necessary, each container is transferred to a de-clumper 2 to break up and separate the individual pellets to allow feeding into the injection molders 4. The individual pellets are collected in a container 3 and then vacuum fed to a feeder 5 leading to the injection molders for forming.

As the pellets are conveyed across the injection molder screw 6, the high temperatures, shear and pressure generated by the screw transforms the solid pellets into a melted product that can be injected into the mold 7 and take form. The melted product travels through the sprue and/or manifolds, runners and/or nozzles and then the cavities to form the final product shape. Once the shot is complete, the injection screw will retract and refill with melted product for the next shot.

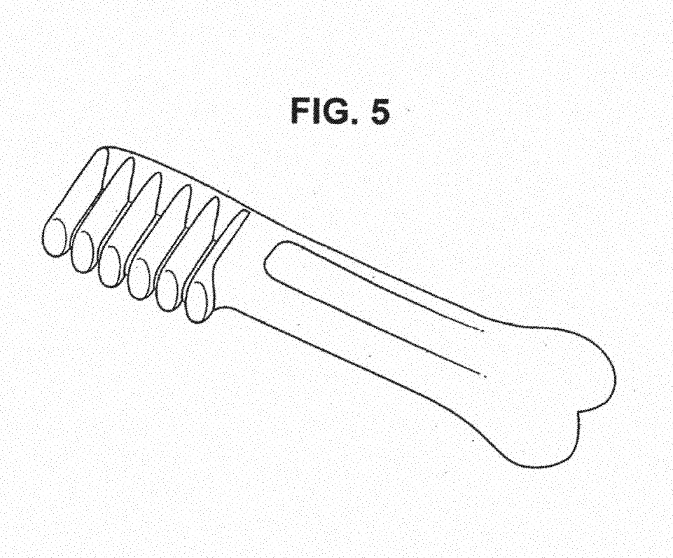

As the injection molder is being filled, the formed products in the cavities are either cooled or heated as required to cool and/or set the products. Once the desired cooling or set time is achieved, the mold opens and the products are released from the cavities through ejector pins on the backside of the product. The molded products fall on to a mechanical conveyor, which are subsequently collected for cooling. If runners are present, they are removed and the molded products are laid out on a cooling table to allow the temperature of the bones to reach ambient temperature prior to packaging. An exemplary molded pet chew is shown in FIG. 5.

Exemplary injection molding process parameters for the formation of the molded products are shown in Table 2.

Exemplary injection molding process parameters

| Parameter | Units | Range | |
|---|---|---|---|
| Feed Rate | Kilogram/hour | 20-250 | |
| | (kg/hr) | | |
| Barrel | Degrees Fahrenheit | 60-350 | (16-178° C.) |
| Temperatures | (F.) | | |
| Injection Speeds | Inches/second (in/s) | 1-10 | (2.54-25.4 cm/s) |
| Injection | Pound per square | 5000-25000 | (34.5-172.4 Mpa) |
| Pressures | inch (psi) | | |
| Injection Times | Second (s) | 3-40 | |
| Stroke | Inches/second (in/s) | 0.5-8.0 | (1.27-20.32 cm/s) |
| Screw Speed | Revolutions per | 50-300 | |
| | minute | | |
| Mould | Degrees Fahrenheit | 140-350 | (60-178° C.) |
| Temperatures | (F.) | | |

| | | |
|---|---|---|
| Cooling/Set | Second (s) | 10-175 |
| Times | | |

Once enough molded products are collected, they are transferred to the de-flasher to remove excess flash. At the exit of the de-flasher, the product is screened where the de-flashed products are sent for packaging and flash is collected for regrind. Flash that is removed throughout the system and products that do not meet product specifications are also collected and used for regrind.

It is also possible to simply admix the ingredients for the formulation and go directly to the injection molder so long as the parameters are controlled to achieve thermoplasticization of the formulation.

Product performance of the pet chew is measured against a number of criteria including plaque and tartar reduction, breath freshening, lasting time, palatability as measured by paired preference, solubility, textural attributes including hardness, density, elasticity, friability, water absorption capacity, and speed of solubilization.

Texture measurements were performed with a TA.HDi Texture Analyzer (Texture Technologies Corp., Scarsdale, N.Y.) equipped with a 250-500 kg load cells. A 5 mm diameter cylindrical probe was used for uniaxial compression or puncture tests, and the tests were conducted at a room temperature of 25° C. Data was collected using the Texture Expert software (version 2.12) from Texture Technologies Corp. Two different uniaxial compression or puncture tests were run. These tests were selected because they best resemble the biting and chewing of the test samples by dogs.

The compression analysis parameters are as follows. Work (W) is defined as an estimate of work; and therefore shows the toughness of the product. A tough product will have a higher work value than a less tough product. The area shows the “force” or load that must be applied to the product to cause it to break. The area under the curve represents toughness. The expressed “Area” units come from the multiplication of y-axis per x-axis as N*mm. To convert “Area” to Work-W-(F/d) multiply by 0.1020408 m²/mm/s².

The Max Force (N) is defined as the maximum amount of force needed to overcome the product's hardness. Usually a hard product will be associated with high ordinate (y-axis) values. The expressed “Force” unit derives from a direct association with mass weight in kg. To convert “Force” to “Max Force”-N-multiply by 9.81 m/s² (the acceleration of gravity).

Travel (mm) is represented as the point (distance) at which the peak force is reached. Thus it emulates the resistance of the product as a combination between toughness and hardness, in addition to elasticity, attributed to a measurement of how far the probe has traveled to reach the maximum force. Larger travel numbers are indicative of more elastic products. Resistance to breaking is directly proportional to travel values.

Linear Distance (mm) is calculated by measuring the length of an imaginary line pulled taunt joining all the trajectory points. This measure describes crumbly verses cohesive product attributes. It is a direct assessment of brittleness where a brittle product will produce more sharp peaks, resulting in a higher linear distance.

The values of hardness, toughness, elasticity, toughness were determined using whole product samples. A base platform, as observed with the TA.HDi, provided by Texture Technologies, was used to measure force/distance. An exemplary product sample that was made and tested is shown in FIG. 5.

The sample was centered on the platform such that the knife will contact one location along the sample bone length at a time. Chosen locations included the brush head, the joint of the shaft to the brush head and the knuckle at the end of the shaft of the pet chew. Each location is contacted with the knife at a 90° angle while the sample is laying on its side placed on a flat platform surface. This is repeated at the three chosen locations along the length of the bone. The brush head, the joint of the shaft to the brush head and the knuckle at the end of the shaft of a pet chew are clearly visible in FIG. 5. A minimum of 5 bones is generally measured per evaluated variable, with each of the following conditions.

Two Sets of Tests were Conducted with the Following Parameters:

A. The circular probe or knife is run at a (1) pre test speed of 5 mm/s (speed of probe before contacting sampling); (2) a test speed of 2 mm/s (speed of probe while travelling within the sample); (3) a post test speed of 5 mm/s (speed that the probe is withdrawn from the sample); and a distance of 50% compression (distance that probe travels within the sample until it is withdrawn).

B. The circular probe or knife is run at a (1) pre test speed of 5 mm/s (speed of probe before contacting sampling); (2) a test speed of 10 mm/s (speed of probe while travelling within the sample); (3) a post test speed of 5 mm/s (speed that the probe is withdrawn from the sample); and a distance of 50% compression (distance that probe travels within the sample until it is withdrawn).

The force in kg (y axis) is plotted against distance in mm (x axis) in which the starting force of 0 may be set as point 1 on the graph and the Max Force may be set as point 2 on the graph. The following parameters were measured: the Max Force 2, which is the maximum force value of the curve, is a measurement of hardness; the Linear Distance (mm), is calculated by measuring the length of an imaginary line pulled taunt joining all the trajectory points. It is a direct assessment of brittleness where a brittle product will produce more sharp peaks, resulting in a higher linear distance. For each of these parameters, the measurement was the average of the values of at least 5 samples of the product tested.

Hardness is measured as Max Force in N. As measured in the uniaxial compression or puncture test, the hardness or max force value of the inventive product, in certain embodiments, for the inventive pet chew is about 100 to about 700 Newtons, preferably about 150 to about 600 Newtons, more preferably about 200 to about 500 Newtons and most preferably about 250 to about 400 Newtons when the pet chew is designed for a dog that weighs less than 11.4 kg (25 lbs) or about 200 to about 800 Newtons for a pet chew designed for a dog that weighs 11.4 kg (25 lbs) or more measured as described above using a probe speed of 2.0 mm/sec. In a preferred embodiment, the pet chew designed for a dog that weighs 11.4 kg or more has a hardness measurement of about 250 to about 650 Newtons, preferably about 275 to about 600 Newtons, and more preferably about 350 to about 550 Newtons measured using a probe speed of 2.0 mm/sec.

The toughness, measured as Newtons×mm (N*mm), of the inventive product has a range of about 500 to about 12,000 N*mm, a preferred range of about 700 to about 10,000 N*mm, and a more preferred range of about 800 to about 5000 N*mm.

The hardness of the pet chew may be formulated based on both dog skull type and weight. In this embodiment, the hardness range for each category of dog type is set forth in the table below.

| | Dog Size | | |
|---|---|---|---|
| Skull type | Small <10 kg | Medium 10-20 kg | Large >20 kg |
| Dolichocephalic | | | |
| hardness range (N) | 33-1270 | 300-2125 | 445-2295 |
| preferred range | 50-1220 | 350-2040 | 540-2210 |
| most preferred range | 65-1125 | 410-1875 | 665-2030 |
| Mesaticephalic | | | |
| hardness range (N) | 140-1850 | 215-2700 | 485-3630 |
| preferred range | 170-1785 | 235-2600 | 560-2500 |
| most preferred range | 210-1050 | 260-2380 | 700-3200 |
| Brachycephalic | | | |
| hardness range (N) | 125-1535 | 150-3100 | 710-4780 |
| preferred range | 145-1480 | 145-3010 | 875-4590 |
| most preferred range | 180-1375 | 140-2760 | 1100-4200 |

The brittleness or linear distance of the inventive product was measured. The brittleness value of the inventive product has a range of about 100 to about 1500 mm, a preferred range of about 150 to about 1300 mm, and a most preferred range of about 200 to about 1000 mm.

### EXAMPLES

### Example 1

A pet chew composition was prepared:

| | Liquid/ | |
|---|---|---|
| Ingredients | Powder | Weight percent |
| Fibrous protein | Powder | 30-50% |
| Gelling protein (Gelatin 100-200 | Powder | 15-25% |
| Bloom) | | |
| Glycerine | Liquid | 15-25% |
| Water | Liquid | 5-15% |
| Hydrogenated Starch Hydrolysate | Liquid | 0-15% |
| Flavor enhancer | Powder | 1-10% |
| Fat | Liquid | 1-10% |
| Nutrients | Powder | 3-7% |
| Preservative | Powder | 0.05-0.55% |
| Colorant | Powder | 0.005-0.045% |

The water activity of the final products ranges from 0.2-0.85. In addition, individual ingredient levels and ratios of liquid to powder may be modified to obtain various final product textures. Further, replacing ingredients with alternatives may also result in different final product textures. For example, the use of 200-bloom gelatin instead of 100-bloom gelatin would result in a firmer product.

### Example 2

A pet chew composition was prepared:

| Ingredients | Weight percent |
|---|---|
| Wheat Protein Isolate | 17% |
| Soy Protein Isolate | 14% |
| Sodium Caseinate | 8% |
| Glycerin | 17% |
| Hydrogenated Starch Hydrolysate | 9% |
| Gelatin (100 Bloom) | 17% |
| Water | 7% |
| Vegetable Oil | 3% |
| Flavor/Nutrients/Preservatives/Colorant | 8% |

### Example 3

A pet chew composition was prepared:

| Ingredients | Weight percent |
|---|---|
| Wheat Protein Isolate | 18% |
| Soy Protein Isolate | 15% |
| Sodium Caseinate | 8.5% |
| Glycerin | 17.5% |
| Hydrogenated Starch Hydrolysate | 2.8% |
| Gelatin (100 Bloom) | 18.5% |
| Water | 9.2% |
| Corn Oil | 1.5% |
| Flavor/Nutrients/Preservatives/Colorant | 9% |

### Example 4

A pet chew composition was prepared:

| Ingredients | Weight percent |
|---|---|
| Wheat Protein Isolate | 18.8% |
| Soy Protein Isolate | 15.6% |
| Sodium Caseinate | 8.9% |
| Glycerin | 15.8% |
| Hydrogenated Starch Hydrolysate | 2.5% |
| Gelatin (100 Bloom) | 19.3% |
| Water | 8.3% |
| Corn Oil | 1.4% |
| Flavor/Nutrients/Preservatives/Colorant | 9.4% |

### Solubility

The in vitro measurement of solubility/digestibility of a pet chew may be used to indicate the amount of the pet chew that would solubilize or be digested in the gastrointestinal tract of a pet, and particularly a dog. The test performed is based on a portion or whole piece of a pet chew product. A particular size portion or piece, e.g., a 32-gram pet chew portion, may be used so that different formulations can be accurately compared. The outcome is expressed as percent (%) in vitro disappearance (IVD). The solubility measurement is performed by subjecting a specific amount of product to a number of solutions which represent the stomach and intestinal environments of a pet. Generally, the stomach environment is relatively acidic and the intestinal environment is relatively more alkaline compared to the stomach. After subjecting the product to these environments, any product left is filtered and dried. This leftover product is weighed and compared with the weight of the initial product. Percent IVD is the percentage of the weight of the dissolved product in comparison to the weight of the initial product. The solubility test is further described below.

### Solutions Utilized:

Phosphate Buffer, 0.1M, pH 6.0 Solution: 2.1 grams of sodium phosphate dibasic, anhydrous, and 11.76 grams of sodium phosphate monobasic, monohydrate were dissolved in a 1 liter volumetric flask and brought up to volume with distilled/deionized (dd) water.

HCl Solution: 17.0 ml concentrated HCl was added to a 1 liter volumetric flask containing 500 ml dd water and brought up to volume with dd water. When 100 ml of HCl:pepsin is added to 250 ml of phosphate buffer, the pH should be close to 2.0. One way to achieve this is to use 850 ml of 0.1 N HCl+150 ml of 1 N HCl to make 1000 ml of HCl stock solution. When 100 ml of HCl:pepsin is added to 250 ml phosphate buffer, the pH of the solution is about 1.9-2.0.

HCl:Pepsin Solution: The appropriate amount of pepsin (Sigma P-7000, pepsin amount is dependent on sample size being tested. 0.01 gram pepsin per 1 gram sample must be obtained in the final mixture at Step 6 of the procedure. For example 0.3 gram pepsin would be used for 30 grams sample) was placed in a 1 liter volumetric flask and brought up to volume with the HCl solution made above.

Chloramphenicol Solution: 0.5 gram chloramphenicol (Sigma C-0378) was brought up to volume in a 100 ml volumetric flask with 95% ethanol.

Sodium Hydroxide Solution, 0.5N: 20 grams NaOH was brought up to volume in a 1 liter volumetric flask with dd water.

Phosphate Buffer, 0.2M, pH 6.8 Solution: 16.5 grams of sodium phosphate dibasic, anhydrous, and 11.56 grams of sodium phosphate monobasic, monohydrate were dissolved in a 1 liter volumetric flask and brought to volume with distilled water.

Pancreatin:Phosphate Buffer Solution: The appropriate amount of porcine pancreatin (Sigma P-1750, enzyme amount is dependent on sample size being tested. 0.05 gram porcine pancreatin per 1 gram sample must be obtained in the final mixture of Step 8. For example, 1.5 grams of pancreatin would be used for 30 grams samples) was dissolved in a 500 ml volumetric flask and brought up to volume with 0.2M, pH 6.8 phosphate buffer solution made above.

### Procedure Example

1. Place numbered pieces of dacron fabric in a 57° C. oven overnight and weigh the next day.

2. Weigh samples into Erlenmeyer flasks. (Weigh additional sample to dry as a control along with residue to account for moisture loss during % IVD calculation). Add 250 ml 0.1M pH6.8 Phosphate Buffer Solution to each flask.

3. Add 100 ml HCl:Pepsin Solution to each flask. Check that the pH of the mixture is about 2. Adjust with HCl if needed.

4. Add 5 ml Chloramphenicol Solution to each flask.

5. Stopper the flasks. Mix gently. Incubate at 39° C. for 6 hours. Mix on a regular basis using a shaking water bath, set at a speed that causes the samples to constantly move in the flask while keeping the products submerged in the solution.

6. After incubation, add enough 0.5N Sodium Hydroxide Solution to each flask to reach a final pH of 6.8 for the mixture.

7. Add 100 ml Pancreatin:Phosphate Buffer Solution to each flask. Mix gently.

8. Stopper the flasks. Incubate at 39° C. for 18 hours. Mix on a regular basis using a shaking water bath, set at a speed that causes the samples to constantly move in the flask while keeping the products submerged in the solution.

9. Filter the sample through tared pieces of dacron fabric from Step 1. Rinse with three times with dd water. Maintain at 57° C. until constant weight is reached.

10. Record pH at the following stages:

a. At step 4.

b. After 6 hours of digestion.

c. After addition of NaOH solution at step 7.

d. After addition of pancreatin:phosphate buffer solution.

e. After 24 hours.

### Calculations:

$$Residue Weight = ( Filter + Sample weight after incubation ) - Dry filter weight$$

$$\% IVD = 1 - \frac{( Sample residue weight ) - ( Blank residue weight )}{Dry matter weight} \times 100$$

In certain embodiments, the pet chew composition possesses a solubility of at least 60% IVD, preferably at least 70% IVD and more preferably at 75% IVD based on a maximum 32-gram piece (if the pet chew is less than 32 grams then typically a single chew product of a given gram weight will be used. It is not recommended to use a piece larger than 32 gram for a realistic reading. Of course one of ordinary skill will recognize that the mass of the pieces analyzed need to be substantially equivalent to make a comparison of the solubility numbers). While the solubility of the pet chew of this invention may be close to 100%, it generally will be in the range of about 60 to about 95% IVD. The solubility of a pet chew made from the formulation of Example 2 by extrusion and injection molding as described herein was about 85% IVD.

### Example 5

### Materials and Methods

The pet chew composition will be produced according to the formulations in Examples 1, 2, and 3, except that the colorant will be a combination of turmeric and anthocyanins. The turmeric will be provided in a powder form. The anthocyanins will be provided in the form of red cabbage and/or blood orange. The color of the resulting pet chew will be a green color. The green color will be naturally derived and have beneficial health properties.

### Results and Conclusions

The resulting pet chew will be a green color that is pleasing to pets and owners. The green color will be naturally-derived leaving open the possibility of a “natural” pet chew. Further, the physical characteristics of the composition including the all-natural ingredients of turmeric and anthocyanins will be substantially the same as set forth above.

### Example 6

This example provides three formulations of preferred pet chews of the present invention, a regular pet chew, a lite pet chew, and a senior pet chew.

### Materials and Methods

Pet Chew Formulations for Regular Pet Chew, Lite Pet Chew, and Senior Pet Chew

TABLE 3

| | | Label |
|---|---|---|
| | Limits | Declaration |
| Parameter | (Min/Max) | (%) |
| Pet Chew | | |
| Crude Protein | Minimum | 52.00 |
| Crude Fat | Minimum | 5.00 |
| Crude Fiber | Maximum | 1.50 |
| Moisture | Maximum | 15.00 |
| Senior Pet Chew | | |
| Crude Protein | Minimum | 19.00 |
| Crude Fat | Minimum | 4.00 |
| Crude Fiber | Maximum | 5.00 |
| Moisture | Maximum | 18.00 |
| Lite Pet Chew | | |
| Crude Protein | Minimum | 21.00 |
| Crude Fat | Minimum | 4.00 |
| Crude Fiber | Maximum | 5.00 |
| Moisture | Maximum | 18.00 |
| Kcal/Kg | Maximum | 2936 max |
| | | 3100 |

TABLE 4

| | | | Lite | Senior |
|---|---|---|---|---|
| GUARANTEED ANALYSIS | | Pet Chew | Pet Chew | Pet Chew |
| Crude Protein | min % | 52.0 | 21.0 | 19.0 |
| Crude Fat | min % | 5.0 | 4.0 | 4.0 |
| Crude Fiber | max % | 1.5 | 5.0 | 5.0 |
| Moisture | max % | 15.0 | 18.0 | 18.0 |
| Calcium | min % | 0.6 | 0.6 | 0.6 |
| Phosphorus | min % | 0.4 | 0.4 | 0.4 |
| Vitamin A | min IU/kg % | 6000 | 4500 | 4500 |
| Vitamin E | min IU/kg % | 650 | 650 | 650 |
| Glucosamine | max IU/kg % | | | 48 |
| Chondroitin | max IU/kg % | | | 450 |

| | |
|---|---|
| Calorie Content (Calculated) | |
| Calorie Content kcal/kg ME | 2936 |
| Calories/Serving | 83 |

All three pet chew embodiments will be formulated using turmeric and anthocyanins to produce an all natural pet chew.

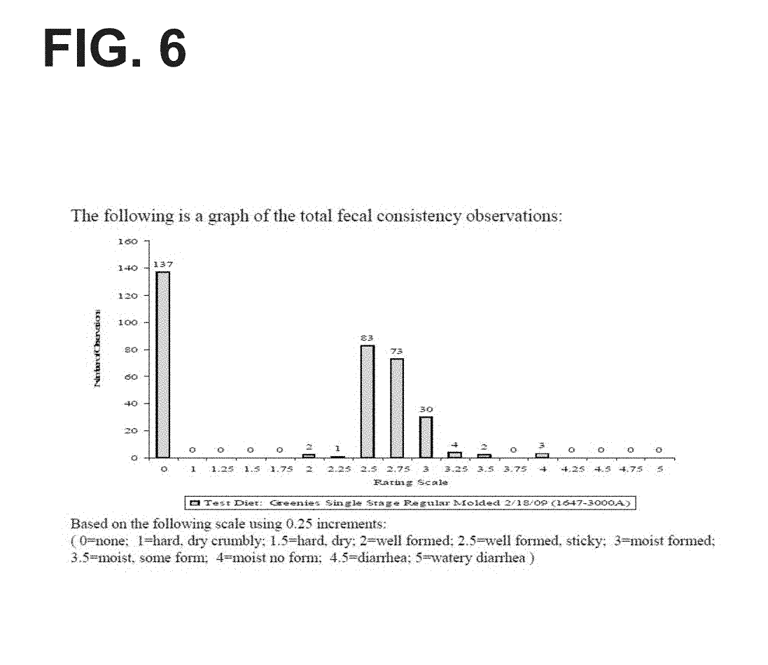

The following are the results of a digestibility and solubility test. Fecal consistency observations are shown in FIG. 6.

Digestibility Study Results

TABLE 5
Digestibility Studies

| | Pet Chew | | Lite Pet Chew | |
|---|---|---|---|---|
| | Mean | SEM | Mean | SEM |
| Dry Matter (total) Digestibility | 92.6 | ±0.51 | 84.0 | ±0.48 |
| Protein Digestibility | 96.2 | ±0.19 | 89.0 | ±0.53 |
| Fat Digestibility | 88.0 | ±0.76 | 75.2 | ±0.86 |
| Caloric Digestibility (using Atwater | 93.9 | ±0.48 | 89.0 | ±0.45 |
| calculation) | | | | |
| Metabolizable Energy (M.E.) kcal/g | 3.65 | ±0.021 | 3.22 | ±0.016 |
| (using Atwater calculation) | | | | |
| Caloric Digestibility (using Bomb | 94.6 | ±0.35 | 84.0 | ±0.52 |
| Calorimetry) | | | | |
| Metabolizable Energy (M.E.) kcal/g | 3.68 | ±0.015 | 3.16 | ±0.020 |
| (using Bomb Calorimetry) | | | | |

Solubility Study Results

TABLE 6

| | | | Dried | | | | | | | |
|---|---|---|---|---|---|---|---|---|---|---|
| | | Dacron | Sample and | | | | | PH | PH | |
| Sample | Test | Fab Wt. | Fabric Final | Residue | Blank | | Avg. | Reading | Reading | Sample |
| Sets | Code | (g) | Wt. (g) | Wt. (g) | Residue | % IVD | % IVD | Step 4 | Step 7 | Wt. (g) |
| Lite Pet | GLN A | 3.4 | 8.5 | 5.10 | 0.10 | 83.77% | 83% | 2.00 | 6.80 | 30.8 |
| Chew A | | | | | | | | | | |
| Lite Pet | GLN B | 3.5 | 8.7 | 5.20 | 0.10 | 83.44% | | 2.00 | 6.80 | 30.8 |
| Chew B | | | | | | | | | | |
| Lite Pet | GLN C | 3.5 | 9.0 | 5.50 | 0.10 | 82.47% | | 2.00 | 6.80 | 30.8 |
| Chew C | | | | | | | | | | |
| Senior Pet | 4SPT0 A | 4.4 | 10.3 | 5.90 | 0.10 | 81.29% | 81% | 2.00 | 6.80 | 31.0 |
| Chew A | | | | | | | | | | |
| Senior Pet | 4SPT0 B | 3.7 | 9.9 | 6.20 | 0.10 | 80.32% | | 2.00 | 6.80 | 31.0 |
| Chew B | | | | | | | | | | |
| Senior Pet | 4SPT0 C | 4.8 | 11.0 | 6.20 | 0.10 | 80.32% | | 2.00 | 6.80 | 31.0 |
| Chew C | | | | | | | | | | |

TABLE 7
6 hr Gastric (HCl/Pepsin) with 18 hr Small Intestine (Pancreatin)

| | | | | | | | | | | | | |
|---|---|---|---|---|---|---|---|---|---|---|---|---|
| | | | Residue | | | | | | | | | |
| # | Spl. Wt. | Spl. Wt. | Wt. | % DMD | Length | Width | Height | Width | Height | Length | Width | Height |

| | | | | | | | | | | |
|---|---|---|---|---|---|---|---|---|---|---|
| 10 | 29.6090 | 26.4023 | 5.9900 | 77.31 | 105.0 | 22.0 | 15.0 | 26.5 | 17.0 | No Measurements |
| | | | | | | | | | | Possible |
| 11 | 29.6111 | 26.4042 | 5.5857 | 78.85 | 106.0 | 22.5 | 15.0 | 26.0 | 17.0 | No Measurements |
| | | | | | | | | | | Possible |
| 12 | 29.6352 | 26.4257 | 4.5052 | 82.95 | 106.0 | 22.0 | 15.0 | 26.0 | 17.0 | No Measurements |
| | | | | | | | | | | Possible |

### Results and Conclusions

The pet chew formulations in Example 5 show improved digestibility and solubility when compared to pet chews currently available on the market. Further, they provide a natural green color.

What is claimed is:

1. An edible pet chew comprising:
a. fibrous protein in an amount of from about 15 to about 90% by weight of the chew;
b. water absorbing polymer in an amount of from about 5 to about 35% by weight of the chew, wherein the water absorbing polymer is selected from gelling proteins, hydrocolloids, edible hydrogels, and mixtures thereof;
c. plasticizer in an amount of from about 5 to about 40% by weight of the chew;
d. water in an amount of from about 1 to about 20% by weight of the chew; and
e. a combination of anthocyanins and turmeric, wherein the combination of anthocyanins and turmeric provides a green color to the chew.

2. The edible pet chew of claim 1, wherein at least one of the anthocyanins is derived from at least one member of the group consisting of Vaccinium species, such as blueberry, cranberry, and bilberry; Rubus berries, including black raspberry, red raspberry, and blackberry; blackcurrant; cherry; eggplant peel; black rice; Concord grape; muscadine grape; red cabbage; violet petals; black soybean; skins of black chokeberry; Amazonian palm berry; blood orange; marion blackberry; cherry; redcurrant; purple corn; and acai.

3. The edible pet chew of claim 2, wherein the anthocyanins have a pH that allows the anthocyanins to appear blue.

4. The edible pet chew of claim 2, wherein a source of the anthocyanins comprises red cabbage.

5. The edible pet chew of claim 4, wherein the source of anthocyanins has a pH of from 8 to 9.

6. The edible pet chew of claim 1, wherein the turmeric has a pH allowing the turmeric to appear yellow.

7. The edible pet chew of claim 6, wherein the turmeric has a pH of from 4.5 to 6.5.

8. The edible pet chew of claim 1, further including a pH stabilizer adapted to stabilize the pH of the pet chew such that the anthocyanins provide a blue color, which contributes to the green color of the pet chew.

9. The edible pet chew of claim 8, wherein the pH stabilizer further comprises an enzyme.

10. The edible pet chew of claim 1, wherein the combined amount of the anthocyanins and turmeric comprises from about 0.005% to 5.0% by weight of the chew.

11. The edible pet chew of claim 1, wherein the green color produced by the combination of anthocyanins and turmeric has a Pantone reference range of from about P 163-14 U to about P 165-16 U.

12. The edible pet chew of claim 1, wherein the green color produced by the combination of anthocyanins and turmeric has a wavelength of from 490 nm to 560 nm.

13. The edible pet chew of claim 1, wherein the solubility of the pet chew is at least 60% in vitro disappearance (IVD).

14. The edible pet chew of claim 1, further comprising starch in an amount less than about 5% by weight of the chew.

15. A method of preparing an edible pet chew comprising the steps of:
a. forming a pet chew composition by admixing fibrous protein in an amount of 15% to 90% by weight of the composition, water absorbing polymer in an amount of 5% to about 35% by weight of the chew, wherein the water absorbing polymer is selected from gelling proteins, hydrocolloids, edible hydrogels, and mixtures thereof; plasticizer in an amount of 5% to 40% by weight of the composition; water in an amount of 1% to 20% by weight of the composition; and a combination of anthocyanins and turmeric in an amount to produce a green color;
b. thermoplasticizing the pet chew composition; and
c. molding the thermoplastic pet chew composition to form the edible pet chew.

16. The method of claim 15, wherein the anthocyanins and turmeric are mixed with the water prior to combination of any liquid ingredients with any dry ingredients.

17. The method of claim 16, wherein the turmeric and anthocyanins are metered in a mixture of glycerin and water and then added to the dry ingredients.

18. The method of claim 15, wherein the anthocyanins are derived from at least one of a blueberry, a cranberry, a bilberry, a black raspberry, a red raspberry, a blackberry, a blackcurrant, a cherry, an eggplant peel, black rice, a Concord grape, a muscadine grape, red cabbage, a violet petal, a black soybean, a black chokeberry, an Amazonian palm berry, a blood orange, a marion blackberry, a cherry, a redcurrant, a purple corn, or an acai.

19. The method of claim 15 wherein the turmeric is provided in powder form.
